(19) United States
(12) Patent Application Publication
(10) Pub. No.: US 2008/0083167 A1
(43) Pub. Date: Apr. 10, 2008

(54) CHAIN GUIDE INSERT FOR A GARAGE DOOR

(76) Inventors: Robert John Olmsted, Wood Dale, IL (US); David Thomas Mack, Naperville, IL (US); Mark Lee Karasek, Lombard, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/538,708

(22) Filed: Oct. 4, 2006

(51) Int. Cl. E05F 15/10

(52) U.S. Cl. 49/199

(57) ABSTRACT

A chain guide is provided for a garage door operator that reduces frictional forces on the chain guide as the chain moves along a travel path. The garage door operator includes a chain having a portion engaged with a sprocket, with a motor for electrically powering the rotation of the sprocket to thereby move the chain. A chain guide is provided in the operator, with the chain guide defining a path for movement of the chain. The friction reducing insert is disposed in the channel of the chain guide to capture and engage the chain and reduce frictional forces.

### TECHNICAL FIELD

This invention relates generally to moveable barriers and, more specifically, to chain guides for garage doors.

### BACKGROUND

Barrier movement operators generally comprise power and control systems for responding to operator inputs and sensed conditions to move a barrier between open and closed positions with respect to an opening. The barrier may be a door, a gate, a window, a window shade/protector or similar apparatus. Garage door operators are a common form of barrier movement operator. Various types of garage door operator systems utilize a chain to move the garage door. In one arrangement, the chain may be engaged at one end with a sprocket, with the sprocket drivingly connected to a motor. The chain is connected at another end to the door, or to a trolley that is connected to the door. The motor serves to rotate the sprocket, which pushes or pulls the chain to thus raise and lower the garage door.

When the chain is being pulled to open the door, the pulling tensile force from the motor-driven sprocket maintains the chain in a rigid position, so that it can easily raise the door. However, when the chain is being pushed to close the door, the force from the motor-driven sprocket will cause the chain to buckle at a link. Thus, the chain may be captured in a guide, with the structure of the chain guide causing the chain links to stay in a rigid linear position, such that the compressive force on the chain from the motor-driven sprocket can be used to lower the door.

When the chain is captured in a chain guide, the chain creates friction against the surfaces of the guide, which can wear the guide material. Under tensile force, such as when the chain is being pulled by the motor to raise the door, the chain links exert a force against the walls or other structure of the chain guide. Under compressive forces, such as when the chain is being pushed by the motor to lower the door, the chain links want to rotate and the walls and structure of the chain guide prevent such rotation. Thus, potentially greater frictional forces are exerted against the chain guide due to the response of a chain to the compressive forces. As a result, chain guides have typically required lubrication in order to control the friction.

One approach for lubricating the chain guide involves constructing the guide out of a low-friction material. However, the choice of guide material is limited because the guide must be made of a strong material. Such strength is required because the guide also acts as a support rail in many instances and thus must take the full force of the motor with minimal flexing. Therefore, it is often difficult to find a material that has both the necessary strength and the low-friction qualities that are needed. Alternatively, as another approach, a low-friction lubricant may be disposed on the chain guide. However, a lubricant can require greater maintenance, with the chain guide requiring re-lubrication after a period of time. The greasy nature of such lubricants can also result in the lubricated chain and chain guides being messy and difficult to handle. Handling of the chain during installation and maintenance may result in the lubricant being transferred onto the person handling the chain guide and other surrounding surfaces. In addition, the greasy nature of such lubricants can also result in the lubricated chain and chain guides collecting dust and debris. This dust and debris increases the friction as it collects, thereby shortening the life of the product.

Therefore, numerous issues exist with respect to the solutions offered thus far. As a result, a need exists for an effective friction-reducing surface for a chain guide.

### SUMMARY

This need is met and the objects are achieved with the present invention. Generally speaking, pursuant to these various embodiments, a chain operator for a barrier movement apparatus is provided for moving a barrier between open and closed positions. The chain operator comprises a chain, with a portion of the chain engaged with a sprocket. A motor electrically powers the rotation of the sprocket to thereby move the chain. A chain guide comprising a channel defines a path for movement of the chain. A friction reducing insert is disposed in the channel of the chain guide to capture and engage the chain and reduce frictional forces on the chain guide as the chain moves along the travel path.

The insert is generally configured and arranged to engageably cooperate with the channel to secure the insert in the channel. In one embodiment, the channel has ridges and the insert has corresponding grooves to secure the insert in the channel. The cross-section of the insert may also be configured to cooperate with the cross-section of the channel. Preferably, the insert is configured and arranged to capture and retain the chain thereon, such as by cooperating with the contour of the chain.

In one embodiment, the sprocket is supported on a jack shaft, wherein the motor rotates the jackshaft to thereby rotate the sprocket. In this embodiment, a first end of the chain is connected to the movable barrier. In another embodiment, at least one end of the chain is attached to a trolley, such that the sprocket drives the chain to move the trolley. The trolley is connected to the movable barrier to thereby move the barrier between open and closed positions.

The invention may be described with greater clarity and particularity by reference to the accompanying drawings.

### BRIEF DESCRIPTION OF THE DRAWINGS

The above needs are at least partially met through provision of the chain guide insert for a garage door described in the following detailed description, particularly when studied in conjunction with the drawings, wherein:

FIG. 1 comprises a perspective view of a garage with a garage door and trolley door operator system as configured in accordance with various embodiments of the invention;

FIG. 2 comprises a side view of a drive unit housing as configured in accordance with various embodiments of the invention

FIG. 3 comprises a perspective view of a garage with a garage door and jackshaft door operator system as configured in accordance with various embodiments of the invention;

FIG. 4 comprises a perspective view of a chain guide channel as configured in accordance with various embodiments of the invention;

FIG. 5 comprises an end view of a chain guide and insert as configured in accordance with various embodiments of the invention;

FIG. 6 comprises a perspective view of the chain guide and insert shown in FIG. 5 as configured in accordance with various embodiments of the invention;

FIG. 7 comprises an end view of a chain guide and insert as configured in accordance with various embodiments of the invention;

FIG. 8 comprises a perspective view of the chain guide and insert shown in FIG. 7 as configured in accordance with various embodiments of the invention;

FIG. 9 comprises a view of a chain guide into which a chain has been inserted as configured in accordance with various embodiments of the invention;

FIG. 10 comprises an end view of a chain guide and insert as configured in accordance with various embodiments of the invention;

FIG. 11 comprises an end view of a chain guide and insert as configured in accordance with various embodiments of the invention; and

FIG. 12 comprises an end view of a chain guide and insert as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

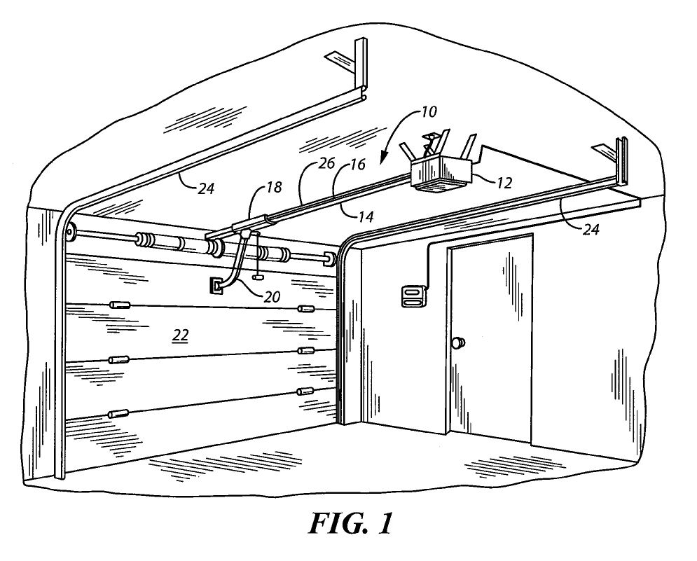

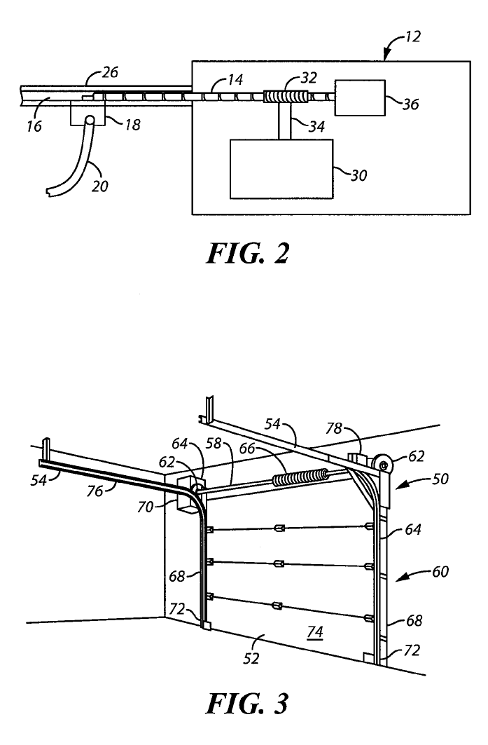

Referring now to the drawings, and in particular to FIG. 1, a barrier movement apparatus, or more specifically, a garage door apparatus is shown therein. The garage door apparatus 10 comprises a drive unit housing 12 mounted to a ceiling of a garage. As shown in FIG. 2, the drive unit housing 12 includes an electric motor 30 and sprocket 32 in driving connection with a chain 14, with a portion of the chain 14 engaged with the sprocket. In FIG. 2, the sprocket 32 is shown being directly mounted to a shaft 34 of the motor drive 30, however, it is understood that the motor drive may be connected to the sprocket through any of a variety of drive assemblies, such as, for example, using additional pulleys, sprockets, and/or belts. The chain is preferably a roller chain. Referring to FIGS. 1 and 2, the chain 14 extends along a chain guide 16 disposed in a rail 26 that extends from the drive unit housing 12. A trolley 18 is connected to the chain 14 and disposed on the rail 26, with the trolley 18 movable along the rail 26 by the chain 14 in the chain guide 16. An arm 20 extends from the trolley 18 to connect the trolley 18 to a multiple paneled garage door 22. The garage door is mounted on a pair of side rails 24.

The garage door apparatus may use a chain formed in a chain loop that pulls the trolley across the rail. The chain loop is looped around the sprocket in the drive unit housing at one end, and around a pulley (not shown) at the door end side of the rail. Alternatively, the chain 14 may comprise a single length of chain that is not looped, such as shown in FIGS. 1 and 2. In this configuration, the chain 14 is connected at one end to the trolley 18 and engaged at an opposite end with the sprocket 32 in the drive unit housing 12. The chain is supported in the chain guide 16 to prevent buckling, particularly when the chain is being pushed to close the garage door 22.

The motor 30 electrically powers the rotation of the sprocket 32 to thereby drive the chain 14 and move the trolley 18 to open and close the garage door 22. In operation, when the motor is energized, the motor rotates the sprocket that is engaged with the drive chain 16 to thereby pull the chain 16 and move the trolley 18 towards the motor to lift the door 22. As the chain is pulled, the chain 16 may be stored in a magazine 36 (FIG. 2) in the drive unit housing 12. When the door 22 is lowered, the motor rotates in the opposite direction, and the sprocket thus pushes the chain 16 in the opposite direction to advance the trolley 18 away from the motor to lower the door 22.

Other garage door and operator configurations are also known in the art. In another embodiment, an alternate garage door operator configuration may be used. Referring now to FIG. 3, a garage door apparatus 50 is shown. The garage door apparatus 50 comprises a movable garage door 52 associated with a garage door opening 60, with the garage door 52 being carried on a pair of L-shaped tracks 54. A jackshaft 58 is mounted horizontally above the door opening 60 and supports a pair of sprockets 62 mounted on either end of the jackshaft 58 to be turned with the jackshaft. Also mounted on the jackshaft 58 are torsion springs 66, which perform a function of counterbalancing part of the weight of the door to reduce the power required to raise the door 52. Other means, such as expansion springs (not shown), may be used to counterbalance the door weight. A drive chain 64 is engaged with each sprocket 62, with the chain 64 being pulled upward or pushed downward by the sprocket and motor to move the door. The chain is preferably a roller chain. Each chain 64 extends along a chain guide 68, wherein the chain guide 68 is adjacent and substantially parallel to the door tracks 54. A first end or ends 72 of the drive chain 64 connect to a bottom panel 74 of the garage door 52.

The garage door apparatus 50 also includes a motor 70 drivingly connected to the jackshaft 58. In operation, when the motor is energized, the jackshaft 58 rotates and the sprocket 62 mounted on the shaft and engaged with the drive chain 68 rotates to pull the chain and lift the door 52. As the door moves upward, the chain 64 may be stored in an upper chain guide section 76 adjacent the door track 54, or may optionally be stored in a magazine 78. When the door is lowered, the motor rotates in the opposite direction, and the sprocket pushes the chain downward. As the door moves downward, the chain 64 may be withdrawn from the upper chain guide section 76, or may optionally be withdrawn from the magazine 78. Alternately, for retrofitting to an existing installation, the drive chain can be attached directly to a sprocket of the motor unit which is not directly attached to the jackshaft.

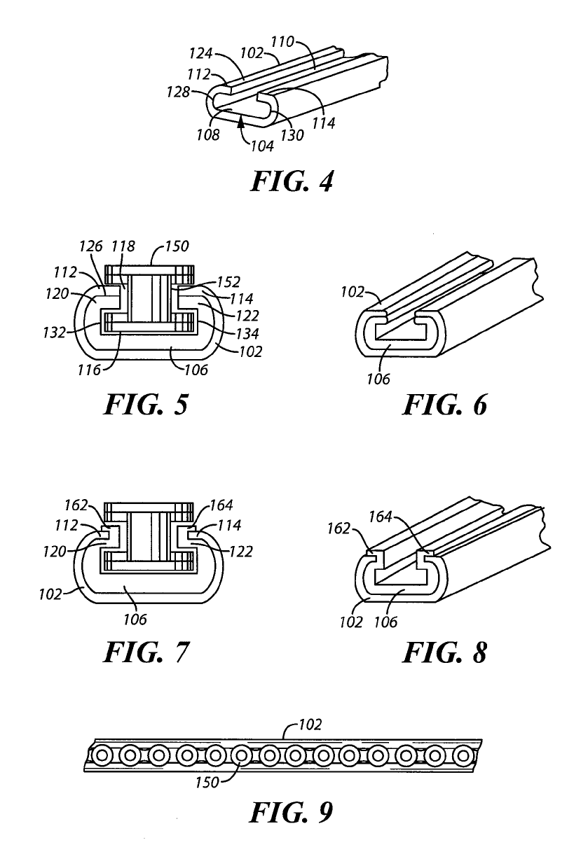

A roller chain can convey forces in compression when it is supported from both sides of its length to keep the chain from bending. Such support can be achieved by passing the chain through a channel in the chain guide that defines a travel path for movement of the chain. Referring to FIG. 4, a chain guide 102 is shown such as would be used in the garage door apparatus 10 of FIG. 1 and the garage door apparatus 50 of FIG. 3. The chain guide 102 has a channel 104, wherein the support provided by the channel 104 permits the chain to be a thrust mechanism and allows the motor to push the chain without the chain buckling. The chain guide 102 is an extruded piece of rigid material such as, for example, aluminum, steel, or a hard plastic. An opening 108 of substantially rectangular cross section is present in the channel. A void 110 extends through an upper wall 124 of the chain guide 102 throughout the length of the guide to provide access to the chain for connections. The void 110 results in two protrusions 112 and 114 extending toward the center of the guide 102. The protrusions 112 and 114 can be used to provide anti-bend support to a roller chain, in addition to the anti-bend support provided by side walls 128 and 130 of the chain guide 102.

As shown in FIG. 5, a friction reducing insert 106 is disposed in the opening 108 of the channel 104 of the chain guide 102 to capture and engage a chain 150 and reduce frictional forces on the chain guide 102 as the chain 150 moves along the travel path. The chain 150 is under tensile forces when the barrier is moving to the open position and the chain is under compressive forces when the barrier is moving to the closed position. The tensile and compressive forces of the chain create frictional forces on the chain guide as the chain travels along the guide. Thus, the friction reducing insert serves to reduce the frictional forces. The insert may be made of a high molecular weight material, such as, for example, a thermoplastic.

As shown in FIGS. 5 and 6, the insert 106 is configured and arranged to engageably cooperate with the channel 104 to secure the insert 106 in the channel 104. In this embodiment, the cross-sections of the chain guide and insert are substantially similar, such that the insert is nested within the channel 104 of the chain guide 102. Thus, the insert also has an opening 116 having a generally rectangular cross section with a void 118 along a top wall 126 of the insert 106 in which the chain 150 can travel. In general, it is preferable for the cross-section of the insert to cooperate with the cross-section of the channel such that the insert will securely fit into the channel of the chain guide.

The insert also has protrusions 120 and 122 for capturing a recessed portion 152 of the chain 150 to retain the chain 150 in the insert 106 and thus in the chain guide 102. The chain slides into the insert 106 in the channel 104 so that the protrusions 120 and 122 restrain the side to side movement of the chain 150. Like the protrusions of the chain guide, the protrusions 120 and 122 of the insert 102 can be used to provide anti-bend support to a roller chain. Further anti-bend support is provided by side walls 132 and 134 of the insert 102. In general, it is preferable for the cross-section of the insert to be configured to cooperate with the contour of the chain to capture and retain the chain. By another optional approach, and referring now to FIGS. 7 and 8, extension portions 162 and 164 of the insert protrusions 120 and 122 may extend up beyond the protrusions 112 and 114 of the chain guide 102 and wrap around a top portion of the chain guide 102, such that substantially no part of the chain 150 touches the chain guide 102, thus providing a lower friction system.

When compression forces are applied to the chain 150 in the guide 102 and insert 106, the chain does not bend and the forces are applied along the chain, with the frictional forces being reduced by the insert. FIG. 9 shows a section of chain guide 102 having a chain 150 therein.

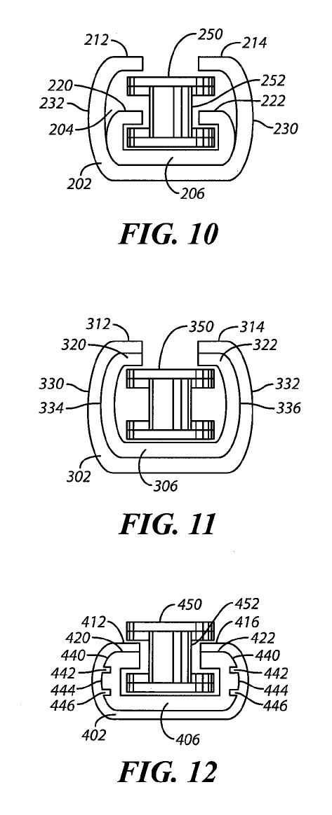

Another illustrative embodiment of a chain guide 202 is shown in FIG. 10. In this embodiment, side walls 230 and 232 of the chain guide 202 may extend above the chain 250, with protrusions 212 and 214 projecting over the chain 250 to retain the chain in the channel 204. The insert 206 may have the same configuration as shown in FIG. 5, with protrusions 220 and 222 for capturing a recessed portion 252 of the chain 250 to thereby retain the chain 250 in the insert 206. Alternatively, as shown in FIG. 11, the side walls 330 and 332 of the chain guide 302 and the side walls 334 and 336 of the insert 306 may both extend above the chain 350, with the chain guide 302 having protrusions 312 and 314 and the insert 306 having protrusions 320 and 322 that both project over the chain 350. Alternatively, only the insert may have the protrusions, with the chain guide having straight side walls, or the chain guide may have protrusions, with the insert having straight side walls. It is preferable for at least one of the chain guide or insert to have the protrusion so as to retain the chain in the chain guide.

In another illustrative embodiment, as shown in FIG. 12, opposing interior walls 440 of the channel 404 of the chain guide 402 may have ridges 442, with corresponding exterior walls 444 of the insert 406 having grooves 446 to thereby allow the insert 406 to engageably cooperate with the channel 404 of the chain guide 402. Alternatively, the channel may have grooves and the insert may have ridges. Further, any of a variety of mating or interconnecting engagements may be used to secure the insert in the channel.

The ridge and groove configuration in FIG. 12 is shown with the chain guide 402 having protrusions 412 and 414 and the insert 406 having protrusions 420 and 422 that both project into the recessed mid-portion 452 of the chain 450. However, it should be noted that the ridge and groove configuration may be used with any of a variety of chain guide and insert arrangements, such as any of those described above.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A chain operator for a barrier movement apparatus comprising:
a chain having a portion engaged with a sprocket;
a motor for electrically powering the rotation of the sprocket to thereby move the chain;
a chain guide comprising a channel defining a path for movement of the chain;
a friction reducing insert disposed in the channel of the chain guide to capture and engage the chain and reduce frictional forces on the chain guide as the chain moves along the travel path.

2. The chain operator according to claim 1 wherein the friction reducing insert comprises a high molecular weight material.

3. The chain operator according to claim 1 wherein the insert is configured and arranged to engageably cooperate with the channel to secure the insert in the channel.

4. The chain operator according to claim 3 wherein the channel has ridges and the insert has corresponding grooves to secure the insert in the channel.

5. The chain operator according to claim 3 wherein the cross-section of the insert is configured to cooperate with the cross-section of the channel.

6. The chain operator according to claim 1 wherein the insert is configured and arranged to capture and retain the chain thereon.

7. The chain operator according to claim 6 wherein the cross-section of the insert is configured to cooperate with the contour of the chain to capture and retain the chain.

8. The chain operator according to claim 1 wherein the chain guide comprises an extruded piece of rigid material.

9. The chain operator according to claim 5 wherein the rigid material is aluminum.

10. The chain operator according to claim 1 wherein the chain comprises a roller chain.

11. The chain operator according to claim 1 wherein the sprocket is supported on a jack shaft and wherein the motor rotates the jackshaft to thereby rotate the sprocket.

12. The chain operator according to claim 1 wherein a portion of the chain is attached to a trolley such that the sprocket drives the chain to move the trolley.

13. The chain operator according to claim 12 wherein the trolley is connected to a movable barrier.

14. The chain operator according to claim 1 wherein a first end of the chain is connected to a movable barrier.

15. A barrier movement apparatus comprising:
a barrier movable between open and closed positions;
a chain having a portion engaged with a sprocket and a first end connected to the barrier;
a motor for electrically powering the rotation of the sprocket to thereby move the chain to open and close the barrier;
a chain guide comprising a channel defining a travel path for movement of the chain; and
a friction reducing insert disposed in the channel of the chain guide and over which the chain moves, wherein the insert captures and engages the chain during chain movement.

16. The chain operator according to claim 15 wherein the insert is configured and arranged to engageably cooperate with the channel to secure the insert in the channel.

17. The chain operator according to claim 15 wherein the insert is configured and arranged to capture and retain the chain thereon.

18. A barrier movement apparatus comprising:
a barrier movable between open and closed positions;
a trolley;
a chain having a portion engaged with a sprocket and a portion connected to the trolley;
a linkage connecting the trolley and the barrier;
a motor for electrically powering the rotation of the sprocket to thereby drive the chain to move the trolley to open and close the barrier;
a chain guide comprising a channel defining a travel path for movement of the chain; and
a friction reducing insert disposed in the channel of the chain guide and over which the chain moves, wherein the insert captures and engages the chain during chain movement.

19. The chain operator according to claim 18 wherein the insert is configured and arranged to engageably cooperate with the channel to secure the insert in the channel.

20. The chain operator according to claim 18 wherein the insert is configured and arranged to capture and retain the chain thereon.
